(19) United States
(12) Patent Application Publication
(10) Pub. No.: US 2026/0085994 A1
(43) Pub. Date: Mar. 26, 2026

(54) Enhanced Sensitivity Fiber Bragg Grating Sensors and Methods of Use

(71) Applicants: The Board of Regents of the University of Oklahoma, Norman, OK (US); Board of Supervisors of Louisiana State University and Agricultural and Mechanical College, Baton Rouge, LA (US)

(72) Inventors: Alberto M. Marino Valle, Knoxville, TN (US); Jyotsna Sharma, Zachary, LA (US); Jagadeeshwar Tabjula, Glasgow (GB); Umang Jain, Norman, OK (US); Saesun Kim, Valley Village, CA (US)

(21) Appl. No.: 19/335,412

(22) Filed: Sep. 22, 2025

Related U.S. Application Data
(60) Provisional application No. 63/698,384, filed on Sep. 24, 2024.

(51) Int. Cl. G01M 5/00; G01K 11/3206; G01L 1/24

(52) U.S. Cl. CPC G01M 5/0091; G01K 11/3206; G01L 1/246; G01M 5/0041; G01M 5/0066

(57) ABSTRACT

A method comprises providing an apparatus configured to generate squeezed light; generating the squeezed light through a specific nonlinear optical process; integrating the squeezed light with an FBG sensor causing reflected light and transmitted light; generating signals by sensing one or more physical parameters of the structure via the FBG sensor; converting the signals to data; and determining that there is a structure alteration in the structure when the data indicates there is a parameter alteration in the one or more physical parameters of the structure as compared to baseline readings of the one or more physical parameters of the structure.

### CROSS-REFERENCE TO RELATED APPLICATIONS

This claims priority to U.S. Prov. Patent App. No. 63/698,384 filed on Sep. 24, 2024, which is incorporated by reference.

### STATEMENT REGARDING FEDERALLY SPONSORED RESEARCH OR DEVELOPMENT

This invention was made with government support under grant number DE-SC0021366 awarded by the Department of Energy. The government has certain rights in the invention.

### BACKGROUND

A fiber Bragg grating (FBG) is a wavelength-sensitive reflector in a portion of an optical fiber that responds to strain or mechanical vibrations and temperature changes. An FBG sensor can detect minor changes in the fiber core's refractive index due to strain or deformation. In short, a strain or temperature change is able to shift the reflection spectrum of the FBG sensor. As a result, if a narrow band laser is launched into the fiber, a shift of the FBG's resonant spectrum will change the reflection and transmission intensity and phase of the laser. This makes it possible to monitor the power or phase of the reflected or transmitted laser to measure changes in strain or temperature.

Fiber sensors based on FBG technology have numerous benefits such as electromagnetic immunity, corrosion resistance, the possibility of multiplexing (or distributed sensing), are light weight, and can withstand high temperature and pressure conditions. In addition, these sensors are compatible with communication systems and are able to perform remote sensing. FBG strain sensors offer high dynamic range with strain measurements typically up to 10,000 μm/m and temperatures up to 700° C. This is why FBG sensors are highly attractive reliable fiber optic solutions for process monitoring in harsh environments.

The fundamental principle behind the operation of an FBG is Fresnel reflection, wherein light traveling between media of different refractive indices may both reflect and transmit at the interface. FBG sensors are made by laterally exposing a small portion of the core of a single-mode fiber to a periodic pattern of intense laser light. The exposure produces a permanent increase in the local refractive index of the fiber's core in that small region, creating a fixed index grating at a particular wavelength AB (the Bragg wavelength) according to the exposure pattern. One important attribute of in-fiber grating sensors over typical fiber-optic intensity-modulated sensors is that the modulation measurement information is wavelength encoded, which makes the sensor self-referencing and independent of fluctuations in source intensity during a measurement.

When light from a broadband source is launched into a fiber having an FBG in its core, the portion of the light from the broadband source at the wavelength λ_{B} undergoes strong reflection while the rest of the spectrum is transmitted (see FIG. 1). The Bragg wavelength satisfies the phase matching condition: λ_{B}=2 nΛ, where n represents the optical fiber mode effective index and Λ is the spatial period of the FBG. Since the refractive index and the grating period are affected by mechanical strain and temperature, the reflected wavelength λ_{B} changes, which means that it can be used to determine strain or temperature changes at the location of the FBG in the fiber.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. The patent or application file contains at least one drawing executed in color. Copies of this patent or patent application publication with color drawings will be provided by the Office upon request and payment of the necessary fec.

FIG. 1 is a schematic that shows the working principle of an FBG sensor with a Bragg wavelength λ_{B}. Light at this wavelength gets reflected out of broadband incident light launched into the fiber, while wavelengths of the spectrum other than AB are transmitted.

FIG. 2 is a schematic depiction of an FBG sensor application for pipeline leak detection and the FBG sensor response to different leak rates.

FIG. 3 depicts a generalized setup for generating squeezed light from a non-linear medium.

FIG. 4 shows an example of an experimentally measured noise spectrum of squeezed light. The top trace represents the shot noise level using a coherent state of light, and the bottom trace represents the noise corresponding to a two-mode squeezed state of light. A maximum of 9 dB squeezing is measured for lower frequencies (below 500 kHz).

FIG. 5 shows a schematic of an FBG sensor with transmitted and reflected squeezed light.

FIG. 6 shows an overall scheme for squeezed light generation, FBG fiber, and detection.

FIG. 7 shows a schematic for interaction of (a) single mode squeezed state of light with a single FBG sensor and (b) two mode squeezed states of light with two FBG sensors and their detection system.

FIG. 8 shows a measured sample transmission spectrum for an FBG sensor designed and fabricated in a polarization maintaining fiber with a resonance wavelength near 794.8 nm, a line width of 0.4 nm, and a reflectivity at the Bragg wavelength of 99%.

FIG. 9 shows a noise spectrum of the light (both classical and squeezed light) reflected by the FBG with a modulation signal, demonstrating a quantum enhanced detection of the signal.

FIG. 10 is a flowchart of a method of using a quantum enhanced-sensitivity FBG sensor.

FIG. 11 is a system for using a quantum enhanced-sensitivity FBG sensor.

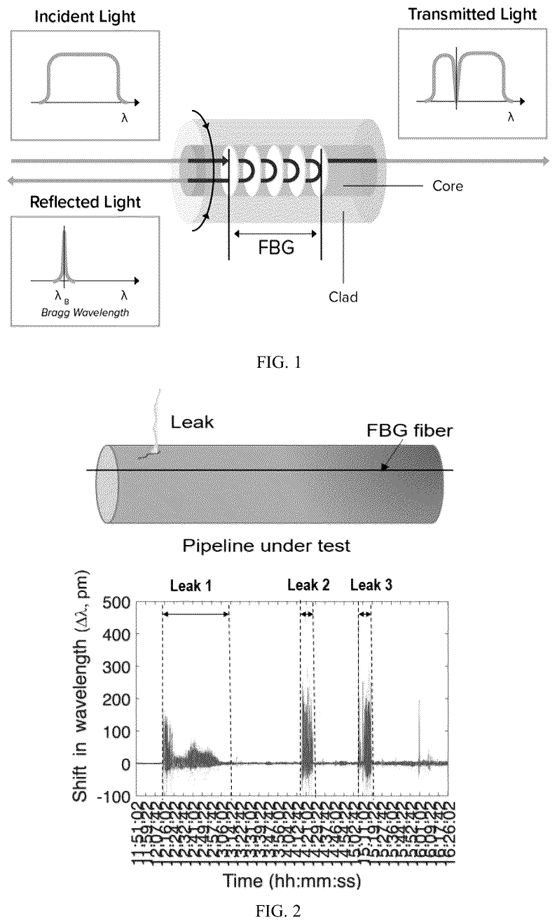

### ABBREVIATIONS

The following abbreviations apply herein:
dB: decibel(s)
EMI: electromagnetic interference
FBG: fiber Bragg grating
FWM: four-wave mixing
kHz: kilohertz
MRI: magnetic resonance imaging
nm: nanometer(s) PPKTP: periodically poled potassium titanyl phosphate
SHM: structural health monitoring
SNL: shot noise limit
SNR: signal-to-noise ratio
® C.: degree(s) Celsius.

### DETAILED DESCRIPTION

Traditionally, FBG sensors have been used with classical broadband light in applications such as leak detection. The present disclosure is directed to systems and methods of quantum sensing using an FBG sensor, in which the source of light input into the FBG sensor is quantum light, also referred to herein as “squeezed light.” Quantum sensing, including optical quantum sensing, is the use of quantum resources to enhance the sensitivity of devices beyond what can be done with classical resources. For FBG sensors, a quantum resource refers to a quantum state of light with noise properties below the classical limit given by coherent states, in other words, squeezed light. Obtaining an enhancement with quantum sensing may require a system that operates at the shot noise limit when used with classical light and that preserves the quantum properties of the light. Quantum sensing enhances the SNR due to a lower noise floor due to the reduced noise properties of the squeezed light. As noted above, a strain or temperature change is able to shift the reflection spectrum of an FBG sensor. As a result, if narrow band laser is launched into the fiber, a shift of the FBG's resonant spectrum will change the reflection and transmission intensity and phase of the laser light. This makes it possible to monitor the power or phase of the reflected or transmitted laser to measure strain or temperature changes. In the present disclosure, narrow band squeezed light is used to probe the FBG sensor. The nature of squeezed light results in reduced noise properties, making it possible to achieve more accurate transmission and/or reflection measurements and hence obtain a better SNR for strain or temperature change measurements. Thus, using squeezed light instead of classical coherent light leads to a reduction in the noise floor while preserving the modulation signal. This leads to a higher SNR, therefore enhancing the sensitivity of the FBG sensor.

Squeezed states are quantum states of light that have reduced noise in either amplitude or phase at the expense of increased noise in phase or amplitude respectively, while still satisfying Heisenberg's uncertainty principle. For an amplitude squeezed state of light, its amplitude is less noisy than the shot noise and hence any measurements of transmission or reflection through an amplitude squeezed light give more precise measurement as compared to a coherent state of light. Since the initial proposals for quantum metrology, several applications that harness temporal quantum correlations in squeezed light have emerged to enhance the sensitivity of devices such as interferometers, magnetometers, plasmonic sensors, accelerometers, and spectroscopic measurements.

Probing FBG sensors with squeezed light thus significantly improves their performance. This is due to the squeezed light's ability to reduce the noise floor below the classical limit given by the photon shot noise. This can significantly enhance the FBG sensor's sensitivity to strain and temperature changes. Moreover, in a distributed sensing configuration, the use of squeezed light with FBG sensors can further enhance the measurement of temperature, strain, or vibration over extended distances, enhancing applications such as pipeline monitoring.

The integration of FBG sensors with squeezed light, as disclosed herein, represents a transformative advancement in optical sensing. Squeezed light, a quantum state with reduced noise properties below the shot noise, is typically generated via parametric amplifiers, including FWM and optical parametric oscillators. Its low-noise characteristic renders it ideal for high-sensitivity, low-noise optical sensing. This combination will provide improved FBG sensing, enabling more precise measurements and a higher SNR in numerous fields, including but not limited to building and infrastructure monitoring and stress control, leak detection in oil and gas structures such as pipes, pipelines, and wellbores, environmental sensing, nuclear reactors, earthquake detection, and biomedical and medical device sensing, via strain detection, temperature sensing, acoustic sensing, and pressure sensing. The use of quantum light, with its reduced noise properties as compared to the shot noise limit, will enhance the sensitivity of FBG sensors. FBG sensors are a robust and cost-effective alternative to detect strain, vibrations, and temperature changes before other approaches.

In a non-limiting example, as illustrated in FIG. 2, an FBG sensor can be laid along an oil or gas pipeline for monitoring and detection of leaks through a disturbance of the FBG by changes in strain and temperature at the leak location. A strain change in the pipeline, caused by fluctuations in fluid flow at a discrete leakage point, is sensed by the FBG. Two FBGs, separated by some distance, can be used to separate out the effect of the change in strain (due to the leak) and a possible change in temperature. This temperature-compensated operation is particularly useful in field applications, such as pipeline monitoring and structural health diagnostics, where environmental conditions vary over time.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. For example, the various apparatus and devices of the various embodiments described herein may be constructed using various off-the shelf components and mechanical and electrical components which perform the same function as the particular components described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

Although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

All patents, published patent applications, and non-patent publications referenced or mentioned in any portion of the present specification are indicative of the level of skill of those skilled in the art to which the present disclosure pertains, and are hereby expressly incorporated by reference in their entireties to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 80% of the time, or at least 90%, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement (e.g., length or thickness).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5

Where used herein, the pronoun “we” is intended to refer to all persons involved in a particular aspect of the investigation disclosed herein and as such may include non-inventor laboratory assistants and non-inventor collaborators working under the supervision of the inventor(s).

The term “remediation” as used here refers to an action taken to address a defect, condition, or status in a structure. For example, the defect or condition may lead to negative consequences if left unremediated. Remediation may include emergency repairs, routine maintenance, corrective maintenance, preventive maintenance, predictive maintenance, rebuilding, replacement of components (e.g., replacing broken or non-functional parts), restoration, reinforcement, upgrading, addressing structural damage,

### EXAMPLES

The inventive concepts of the present disclosure will now be further discussed in terms of several specific, non-limiting, examples and embodiments. The examples described below will serve to illustrate the general practice of the present disclosure, it being understood that the particulars shown are merely exemplary for purposes of illustrative discussion of particular embodiments of the present disclosure only and are not intended to be limiting of the claims of the present disclosure.

### Generation of Squeezed Light:

Squeezed light is a quantum state of light that exhibits reduced noise properties below the shot noise limit. It can be generated using parametric amplifiers such as FWM or optical parametric oscillators. These parametric amplifiers are used to create a nonlinear interaction between different modes of light, resulting in the generation of squeezed light. Narrow linewidth squeezed light can be generated through different nonlinear processes, including FWM in a hot vapor cell or an optical parametric amplifier based on the use of a cavity around a nonlinear crystal, such as a PPKTP crystal. These processes generate single mode or two mode squeezed states of light that exhibit lower noise properties than a coherent light source. A squeezed light source can have reduced amplitude noise, which is related to the intensity noise of the light for enhancing intensity measurements, or reduced phase noise for phase sensing applications that require homodyne detection.

### Construction of FBG Sensor

An FBG is a type of distributed Bragg reflector that is constructed over a short segment of an optical fiber. It has a characteristic reflection spectrum such that it reflects specific wavelengths of light and transmits all others. This is achieved by creating a periodic variation in the refractive index of the fiber core, which generates a wavelength-specific dielectric mirror. Therefore, if a broadband light is coupled to a fiber with an FBG, it will reflect back a specific wavelength and transmit all other wavelengths. This specific wavelength reflection response can be designed and tweaked during fabrication, as it depends on the spacing between the layers of the grating inside the fiber. The resonant wavelength shifts as a result of a change of the environment due to disturbances such as stretching or changing the temperature of the grating, which essentially changes the refractive index and the grating period. Conventionally, any change in environment at the location of the FBG is measured by tracking the wavelength of the reflected light. However, if the light is narrow linewidth and near the resonance wavelength of the FBG, some of the light is transmitted and some is reflected. In this case, changes in the environment around the location of the FBG in the fiber can be precisely measured by measuring the change in the reflected and transmitted intensity or phase of the light.

Integration of FBG Sensor with Squeezed Light

The use of squeezed light with FBG sensors brings a new level of precision and accuracy. The reduced noise characteristics of squeezed light enhance the sensor's ability to detect subtle changes in its environment, leading to higher resolution and sensitivity and thus, more reliable measurements. This integration is pivotal in applications requiring ultra-sensitive detection, where even minimal environmental changes must be accurately monitored.

### Measurement Methodologies

A variety of techniques, including direct and interferometric detection, are employed to measure the intensity and noise characteristics of the transmitted or reflected light. This allows for the precise quantification of environmental changes based on intensity modulation or phase shifts in the light probing the FBG sensor.

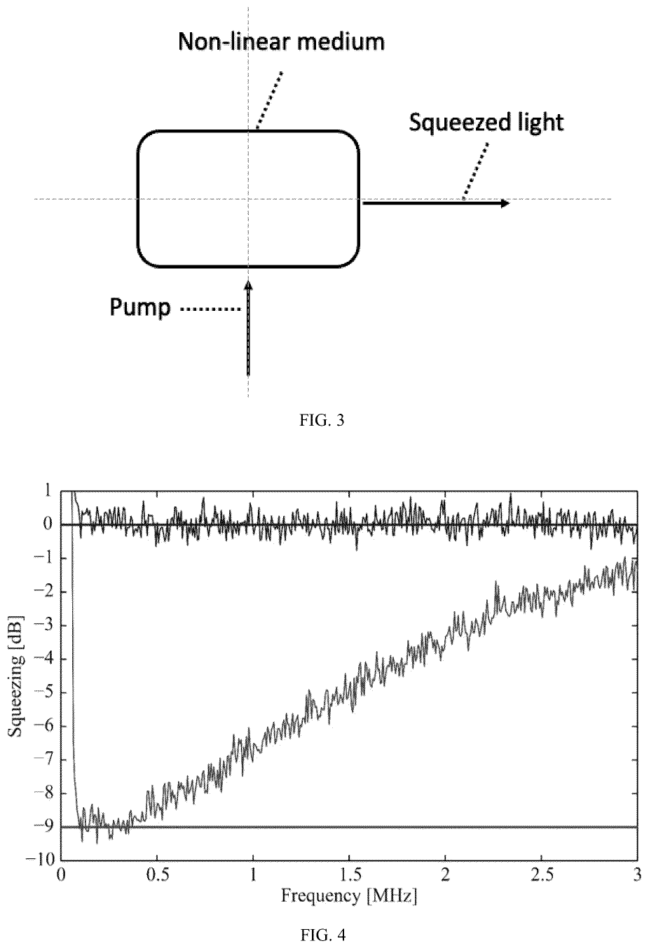

FIG. 3 depicts a highly generalized setup for generating squeezed light, which can be achieved through various nonlinear processes such as FWM or parametric down conversion. The diagram shows a light source interacting with a nonlinear medium, leading to the generation of squeezed light characterized by a quantum reduction in noise. The process results in light with quantum properties, which is then directed towards the FBG sensor. The exact method of squeezed light generation as well as the type of squeezed light (e.g., single mode or two mode) can vary, offering flexibility in the setup.

FIG. 4 shows an example of the experimentally measured noise spectrum of squeezed light. The top trace represents the shot noise level using a coherent state of light, and the bottom trace represents the noise corresponding to a two-mode squeezed state of light. A maximum of 9 dB squeezing is measured for lower frequencies (below 500 kHz).

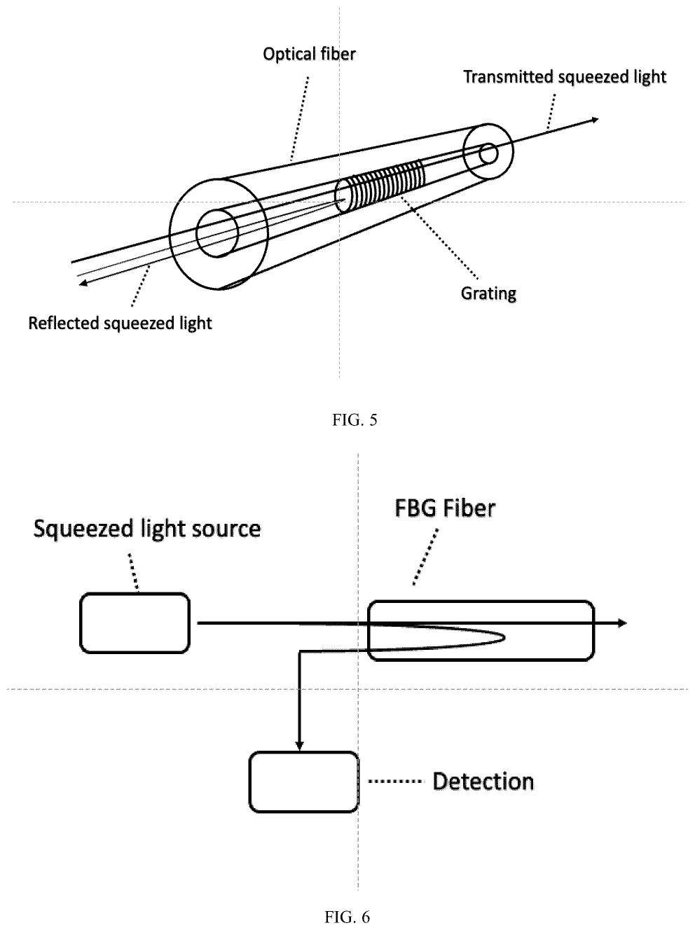

FIG. 5 illustrates the interaction between the narrow band squeezed light and the FBG sensor. The FBG, depicted as a grating within an optical fiber, reflects some amount of squeezed light and transmits some amount of squeezed light.

FIG. 6 shows a highly generalized schematic in which the portion of squeezed light that is reflected is received by a detector. The reflected squeezed light containing the signal due to strain or temperature variations is measured. Alternate measurement configurations include measuring the transmission with the signal and even more advanced techniques could measure both transmission and reflection along with the phase simultaneously.

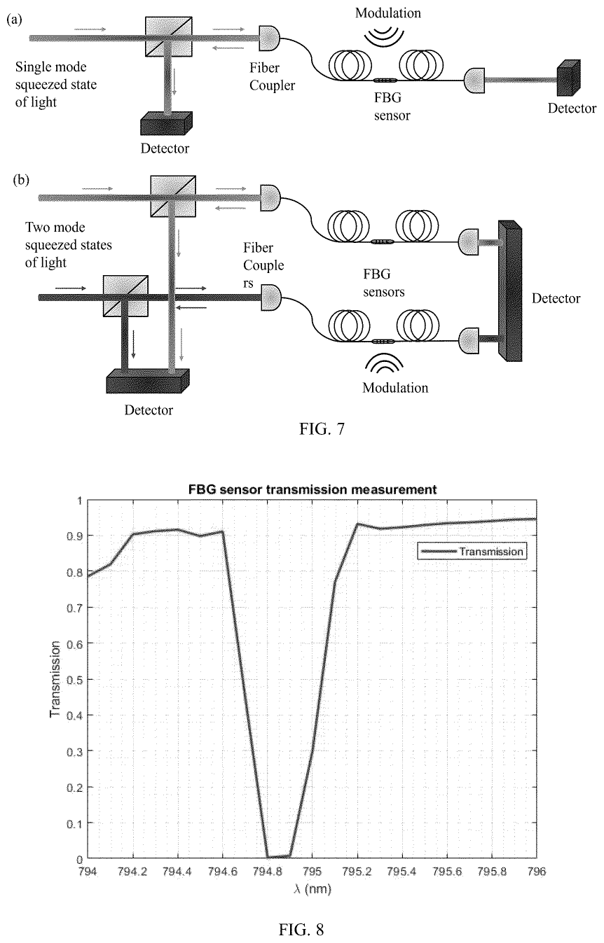

FIG. 7 shows two embodiments of implementations of using squeezed light with the FBG sensor and detection system for the enhanced sensitivity measurement of a modulation. (a) shows an embodiment using a single mode squeezed state of light coupling to a fiber with the FBG sensor and a modulation (due to environmental changes) applied onto the FBG. Both the reflected and transmitted light are modulated due to the FBG modulation, and are detected by the two detectors measuring the intensity change signal. (b) shows two mode squeezed states of light, the conjugate beam on top and the probe beam on bottom or vice versa, coupling into two fibers with FBG sensors with similar response. If the modulation is applied to only one of the FBG sensors, the intensity difference noise measurement cancels out the common background noise, allowing for the signal to be recovered even in the presence of environmental noise while still preserving the quantum enhacement. The detection system for either the reflected or the transmitted light measures the modulation signal with higher SNR. For the two-mode squeezed light configuration, to preserve as much squeezing as possible, quantum correlated spatial regions should be optimally coupled to the fibers.

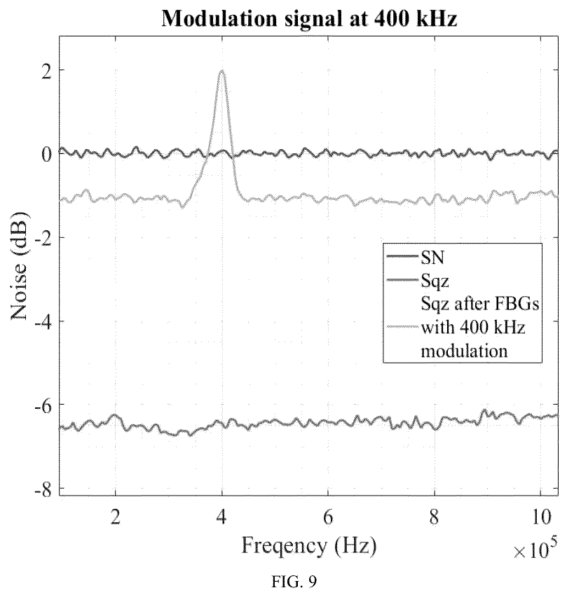

FIG. 8 shows a measured sample transmission spectrum for an FBG sensor designed and fabricated in a polarization maintaining fiber with a resonance wavelength λ_{B} near 794.8 nm, a line width of 0.4 nm, and a reflectivity at the Bragg wavelength of 99%. The device exhibits a tunability of 0.005 nm/° C., and its fabrication in a polarization maintaining fiber leads to shifted resonances for orthogonal polarizations. At the resonance wavelength nearly all optical power is reflected while other wavelengths are transmitted. As a proof of principle and illustration of the technique, the signal due to environmental changes can be emulated by a modulation signal imparted on the FBG through mechanical vibrations introduced with a piezoelectric transducer (see FIG. 9). The mechanical modulation imparts a strain modulation onto the FBG sensor.

FIG. 9 shows the measured modulation signal (at 400 kHz) in the reflected light from the FBG sensor (substantially-middle trace) with 70% coupling efficiency of the squeezed light into the optical fiber containing the FBG. The substantially-top trace represents the shot noise level, while the bottom trace represents the squeezing level generated by the source measured before coupling into the optical fibers. The noise level when using the squeezed light is below the shot noise limit (top trace), indicating that a quantum enhancement is obtained.

### Applications

The disclosed enhanced FBG sensor systems can be used in civil and aerospace engineering structural health monitoring (SHM) applications for structures like bridges, buildings, roads, aircraft, and dams. SHM involves the observation and analysis of a system over time using periodically sampled response measurements to monitor changes to the material and geometric properties of engineering structures such as but not limited to bridges and buildings. They can detect and measure strain, temperature changes, and vibrations, helping to identify potential structural weaknesses or damages early.

In the aerospace and aviation sector, the disclosed squeezed light-enhanced FBG sensors can be used to improve their applications in monitoring the structural integrity of aircraft components. They can be embedded into materials to track stress, strain, and temperature changes in critical parts of aircraft, such as wings and fuselage.

In the automotive industry, the disclosed squeezed light-enhanced FBG sensors can be used to improve their applications for stress and strain monitoring in vehicle components. They can help in the design and testing of new materials and structures, improving safety and performance.

In the oil and gas industry, the disclosed squeezed light-enhanced FBG sensors can be used to improve their applications in pipeline, wellbore, and storage equipment monitoring. They can detect leaks, temperature changes, and structural weaknesses in pipelines, wellbores, and storage equipment earlier, thus helping to prevent accidents and improve maintenance. The fluid can be crude petroleum, refined petroleum, natural gas, or any combination thereof. They can be used in fluid handling systems such as wells, pipelines, wellbores, storage tanks, storage structures, transport structures, or any combination thereof. FBG sensors can also detect solids, such as sands, which are also produced with fluids within the wellbores. The solids create a different strain regime that can be detected within the FBG. In any of these structures the component of the fluid handling system can be undersea or on land, and land-based systems can include surface and/or subsurface components.

The system can also be deployed on monitoring wellbores for the surveillance of subsurface CO₂ sequestration sites to detect leaks or structural integrity issues which could result in CO₂ leaks and emissions. Fluid movement results in temperature and pressure changes that can be detected via the sensor-instrumented monitoring wellbores.

In medical devices and biomedical applications, the disclosed squeezed light-enhanced FBG sensors can be used to improve medical devices for monitoring strain and temperature. They are particularly useful in applications where EMI can be a concern, such as in MRI machines. FBGs can also be used in biomechanical studies and medical prosthetics.

In environmental monitoring, the disclosed squeezed light enhanced FBG sensors can improve applications in environmental sensing to monitor parameters like temperature, humidity, and chemical composition in various environments, from oceans to urban areas.

In the renewable energy sector, the disclosed squeezed light enhanced FBG sensors can improve applications in renewable energy applications, such as wind turbines such as the monitoring of the condition and performance of blades and other critical components. In the nuclear sector, the disclosed system can be used to monitor structural integrity of nuclear power plant, heat efficiency through temperature monitoring.

In the railway industry, the disclosed squeezed light enhanced FBG sensors can improve applications in monitoring railway track integrity, train load distribution, and structural health monitoring of railway bridges and tunnels.

In the safety and security industry, the disclosed squeezed light enhanced FBG sensors can improve applications in security systems for perimeter monitoring, including fence intrusion detection systems.

In the material testing and research industry, the disclosed squeezed light enhanced FBG sensors can improve applications in material testing under various conditions, helping in the development of new materials and structures.

### Method

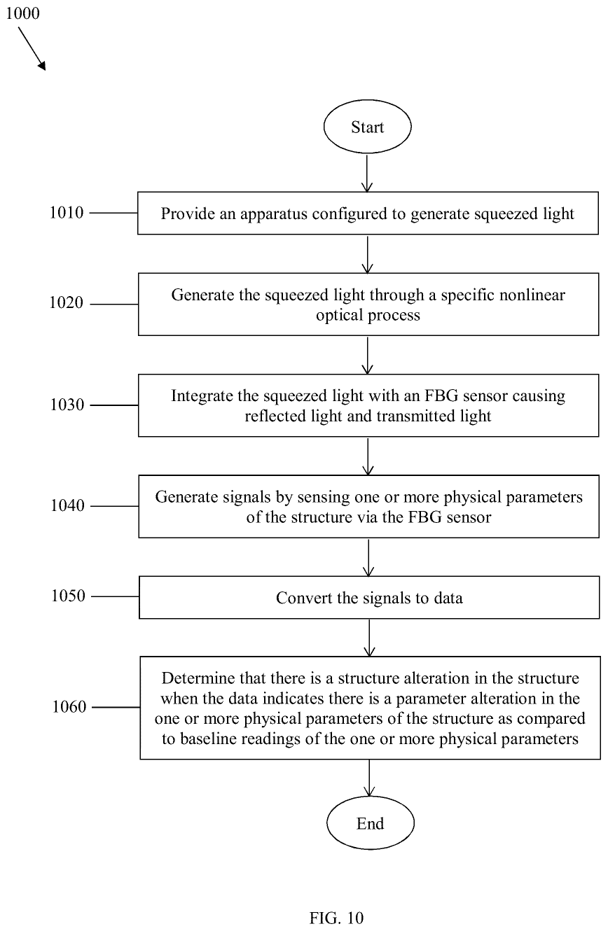

FIG. 10 is a flowchart of a method 1000 of using a quantum enhanced-sensitivity FBG sensor. At step 1010, an apparatus configured to generate squeezed light is provided. At step 1020, the squeezed light is generated through a specific nonlinear optical process. An FBG sensor is calibrated to respond to the squeezed light. At step 1030, the squeezed light is integrated with an FBG sensor causing reflected light and transmitted light. At step 1040, signals are generated by sensing one or more physical parameters of the structure via the FBG sensor. At step 1050, the signals are converted to data. The data comprises at least one of raw FBG wavelength shift data, intensity modulations, phase modulations of the reflected light, or phase modulations of the transmitted light. At step 1060, it is determined that there is a structure alteration in the structure when the data indicates there is a parameter alteration in the one or more physical parameters of the structure as compared to baseline readings of the one or more physical parameters.

Upon the determination that there is at least one parameter alteration, the method 1000 may further comprise conducting a remediation action on the structure that is related to the one or more physical parameters in which there is the parameter alteration. The FBG sensor is physically associated with the structure by being embedded therein or attached thereto. The one or more physical parameters may be selected from a strain, deformation, pressure, vibration, or temperature change in the structure.

In certain embodiments, the structure is selected from a bridge, a building, a dam, a nuclear reactor, a road, a wall, a fence, a tower, a pole, an arch, a cable, a beam, a column, a pillar, a foundation, a frame, and a truss. In certain embodiments, the structure is an aircraft structure selected from a wing, a fuselage, a propeller blade, a window, a door, a landing gear, a stabilizer, an elevator, a rudder, a flap, an aileron, a slat, and an engine cowling. In certain embodiments, the structure is a railway structure selected from a rail, a railway mast, a cantilever bracket, a catenary cable, a contact cable, a rail tie, a track bed structure, a railway bridge, and a railway tunnel. In certain embodiments, the structure is a mobile vehicle selected from an automobile, a truck, a bus, a train engine, a train car, a bicycle, and a motorcycle. In certain embodiments, the structure is a power structure selected from a wind turbine blade, a wind turbine tower, a wind turbine rotor shaft, a power transmission line tower, a power transmission line wire, a power transmission line pole, a power distribution line pole, and a power distribution line wire. In certain embodiments, the structure is a telecom structure selected from a telecom pole, a telecom wire, and a cellular phone antenna tower.

In certain embodiments, the structure is a component of an item of oil and gas equipment, oil and gas storage, or oil and gas transport. The item may be selected from a pipeline, a wellbore, a wellbore casing, a storage tank, a drilling derrick, and a beam pump. In certain embodiments, the structure is a component of an item of oil and gas equipment, oil and gas storage, or oil and gas transport, and the remediation action is a repair of a leak in the structure.

In certain embodiments, the structure is a component of a security system selected from a perimeter, a fence, a wall, a tunnel, an aboveground structure, and an underground structure. In certain embodiments, the structure is a component of a biomedical device selected from a probe, surgical equipment, a surgical tool, an imaging tool, a diagnostic tool, and a robotic arm. The structure may be positioned upon a land surface, below the land surface, or underwater.

### System

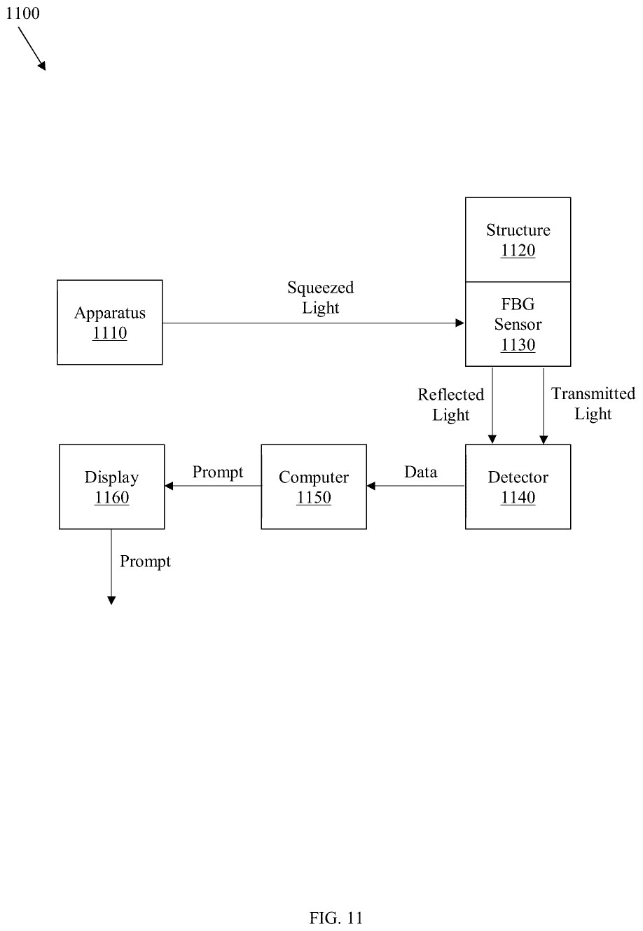

FIG. 11 is a system 1100 for using a quantum enhanced-sensitivity FBG sensor. The system 1100 comprises an apparatus 1110, a structure 1120, an FBG sensor 1130, a detector 1140, a computer 1150, and a display 1160. The system 1100 may implement the method 1000.

The apparatus 1110 is configured to generate squeezed light through a specific nonlinear optical process. The structure 1120 has physical parameters. The FBG sensor 1130 is physically associated with the structure 1120 and configured to respond to the squeezed light to generate reflected light and transmitted light. The detector 1140 is configured to generate, based on the reflected light or the transmitted light, data associated with the physical parameters. The data comprises at least one of raw FBG wavelength shift data, intensity modulations, phase modulations of the reflected light, or phase modulations of the transmitted light. The computer 1150 comprises one or more memories configured to store instructions implementing the disclosed embodiments and comprises one or more processors configured to execute the instructions.

The one or more processors are configured to determine that there is a structure alteration in the structure when the data indicates there is a parameter alteration in the one or more physical parameters of the structure as compared to baseline readings of the one or more physical parameters. The one or more processors are further configured to generate a prompt recommending conducting a remediation action on the structure that is related to the one or more physical parameters in which there is the parameter alteration. The display 1160 is configured to display the prompt. Alternatively, a computer program product, which comprises instructions that are stored on a non-transitory computer-readable medium, may implement the disclosed embodiments.

While several embodiments have been provided in the present disclosure, it is to be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. The claims are not to be limited to the specific sequence of steps show therein. For example, in claim 1, the order of steps (a)-(f) may be changed as long as the ultimate outcome of the process is not substantially diminished. In a non-limiting example, step (d) may occur before, during, or after step (b).

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope of the inventive concepts disclosed herein.

What is claimed is:

1. A method of detecting an alteration in a structure having a fiber Bragg grating (FBG) sensor physically associated therewith, the method comprising the steps of:
(a) providing an apparatus configured to generate squeezed light;
(b) generating the squeezed light through a specific nonlinear optical process, wherein the FBG sensor is calibrated to respond to the squeezed light;
(c) integrating the squeezed light with the FBG sensor causing reflected light and transmitted light;
(d) generating signals by sensing one or more physical parameters of the structure via the FBG sensor;
(e) converting the signals to data, wherein the data comprises at least one of raw FBG wavelength shift data, intensity modulations, phase modulations of the reflected light, or phase modulations of the transmitted light; and
(f) determining that there is a structure alteration in the structure when the data indicates there is a parameter alteration in the one or more physical parameters of the structure as compared to baseline readings of the one or more physical parameters.

2. The method of claim 1, further comprising conducting a remediation action on the structure that is related to the one or more physical parameters in which there is the parameter alteration.

3. The method of claim 1, wherein the FBG sensor is physically associated with the structure by being embedded therein or attached thereto.

4. The method of claim 1, wherein the one or more physical parameters are selected from a strain, deformation, pressure, vibration, or temperature change in the structure.

5. The method of claim 1, wherein the structure is selected from a bridge, a building, a dam, a nuclear reactor, a road, a wall, a fence, a tower, a pole, an arch, a cable, a beam, a column, a pillar, a foundation, a frame, and a truss.

6. The method of claim 1, wherein the structure is an aircraft structure selected from a wing, a fuselage, a propeller blade, a window, a door, a landing gear, a stabilizer, an elevator, a rudder, a flap, an aileron, a slat, and an engine cowling.

7. The method of claim 1, wherein the structure is a railway structure selected from a rail, a railway mast, a cantilever bracket, a catenary cable, a contact cable, a rail tie, a track bed structure, a railway bridge, and a railway tunnel.

8. The method of claim 1, wherein the structure is a mobile vehicle selected from an automobile, a truck, a bus, a train engine, a train car, a bicycle, and a motorcycle.

9. The method of claim 1, wherein the structure is a power structure selected from a wind turbine blade, a wind turbine tower, a wind turbine rotor shaft, a power transmission line tower, a power transmission line wire, a power transmission line pole, a power distribution line pole, and a power distribution line wire.

10. The method of claim 1, wherein the structure is a telecom structure selected from a telecom pole, a telecom wire, and a cellular phone antenna tower.

11. The method of claim 1, wherein the structure is a component of an item of oil and gas equipment, oil and gas storage, or oil and gas transport.

12. The method of claim 11, wherein the item is selected from a pipeline, a wellbore, a wellbore casing, a storage tank, a drilling derrick, and a beam pump.

13. The method of claim 1, wherein the structure is a component of an item of oil and gas equipment, oil and gas storage, or oil and gas transport, and wherein the remediation action is a repair of a leak in the structure.

14. The method of claim 1, wherein the structure is a component of a security system selected from a perimeter, a fence, a wall, a tunnel, an aboveground structure, and an underground structure.

15. The method of claim 1, wherein the structure is a component of a biomedical device selected from a probe, surgical equipment, a surgical tool, an imaging tool, a diagnostic tool, and a robotic arm.

16. The method of claim 1, wherein the structure is positioned upon a land surface, below the land surface, or underwater.

17. A system comprising:
a structure having physical parameters;
an apparatus configured to generate squeezed light through a specific nonlinear optical process;
a fiber Bragg grating (FBG) sensor physically associated with the structure and configured to respond to the squeezed light to generate reflected light and transmitted light;
a detector configured to generate, based on the reflected light or the transmitted light, data associated with the physical parameters, wherein the data comprises at least one of raw FBG wavelength shift data, intensity modulations, phase modulations of the reflected light, or phase modulations of the transmitted light; and
one or more processors configured to determine that there is a structure alteration in the structure when the data indicates there is a parameter alteration in the one or more physical parameters of the structure as compared to baseline readings of the one or more physical parameters.

18. The system of claim 17, wherein the structure is infrastructure, an aircraft structure, a railway structure, a mobile vehicle, a power structure, a telecom structure, an oil structure, a gas structure, a security system structure, or a biomedical structure.

19. The system of claim 17, wherein the apparatus is a parametric amplifier.

20. The system of claim 17, wherein the one or more processors are further configured to generate a prompt recommending conducting a remediation action on the structure that is related to the one or more physical parameters in which there is the parameter alteration, and wherein the system further comprises a display configured to display the prompt.
